(19) United States
(12) Patent Application Publication
(10) Pub. No.: US 2008/0180747 A1
(43) Pub. Date: Jul. 31, 2008

(54) Image Forming Device and Method of Controlling Reprint

(75) Inventor: Toru TSUZUKI, Okazaki (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 12/023,718

(22) Filed: Jan. 31, 2008

(30) Foreign Application Priority Data
Jan. 31, 2007 (JP) 2007-021963

(51) Int. Cl. G06F 15/00

(52) U.S. Cl. 358/1.16; 358/1.15

(57) ABSTRACT

There is provided an image forming device which comprises: a print unit; a connection unit to which an external device is detachably attachable; a print control unit configured to control the print unit in accordance with print target data read from the external device attached to the connection unit to form an image corresponding to the print target data on a recording medium; a storage unit used to store the print target data which has been printed via the print unit; an authentication information input unit configured to accept input of authentication information; and a judgment unit configured to judge whether to permit execution of reprinting of the print target data stored in the storage unit in accordance with the authentication information.

### CROSS-REFERENCE TO RELATED APPLICATION

This application claims priority under 35 U.S.C. §119 from Japanese Patent Application No. 2007-021963, filed on Jan. 31, 2007. The entire subject matter of the application is incorporated herein by reference.

### BACKGROUND

1. Technical Field

Aspects of the present invention relate to an image forming device having a direct print function of directly acquiring image data from an external storage device and executing a printing operation for the acquired image data.

2. Related Art

Image forming devices having the direct print function have been widely used. An example of such an image forming device is disclosed in Japanese Patent Provisional Publication No. 2005-280285 (hereafter, referred to as JP2005-280285A). In this publication, it is disclosed that a digital camera which is a USB device corresponding to a storage class can be connected to a printer. When image data is read from the digital camera connected to the printer, a printing unit of the printer is activated to print an image corresponding to the image data. The image data which has been targeted for the printing operation is automatically stored in internal storage of the printer.

By thus automatically storing, in the internal storage of the printer, the image data for which the printing operation has been executed, it is possible to reprint the image for which the printing operation has been executed, through use of the printer alone. That is, for the purpose of reprinting images, connection of the digital camera to the printer is not required.

### SUMMARY

However, according to the above mentioned configuration of the printer, there is a possibility that an image corresponding to certain image data which has been stored in the printer by a certain user is reprinted through the printer regardless of the certain user's intention. That is, images that the certain user does not want to print might be printed through the printer.

Aspects of the present invention are advantageous in that an image forming device capable of reprinting an image for which a printing operation has been executed, while maintaining excellent security of stored image data is provided.

According to an aspect of the invention, there is provided an image forming device which comprises: a print unit; a connection unit to which an external device is detachably attachable; a print control unit configured to control the print unit in accordance with print target data read from the external device attached to the connection unit to form an image corresponding to the print target data on a recording medium; a storage unit used to store the print target data which has been printed via the print unit; an authentication information input unit configured to accept input of authentication information; and a judgment unit configured to judge whether to permit execution of reprinting of the print target data stored in the storage unit in accordance with the authentication information.

In this configuration, whether to permit the reprinting is judged based on the authentication information. By imposing a condition on execution of the reprinting, the reprinting is prevented from being executed if the condition is not satisfied. Therefore, security regarding the reprinting can be enhanced.

According to another aspect of the invention, there is provided an image forming device which comprises: a print unit; a connection unit to which an external device is detachably attachable; a storage unit used to store print target data which has been printed via the print unit; and a print control unit configured to store, at a stage where the print target data read from the external device attached to the connection unit is stored in the storage unit, authentication information used to judge whether to permit reprinting of the print target data in the storage unit.

With this configuration, it is possible to prevent print data remaining in the image forming device from being printed freely by another user. That is, security of print data can be achieved.

According to another aspect of the invention, there is provided a method of controlling reprinting executed on an image forming device, comprising the steps of: controlling a print unit in accordance with print target data read from an external device attached to the image forming device to form an image corresponding to the print target data on a recording medium; storing the print target data which has been printed via the print unit in a storage unit; accepting input of authentication information; and judging whether to permit execution of reprinting of the print target data stored in the storage unit in accordance with the authentication information.

With this configuration, it is possible to prevent print data remaining in the image forming device from being printed freely by another user. That is, security of print data can be achieved.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 is a perspective view of a printer according to an embodiment.

FIG. 2 illustrates an outer appearance of a computer.

FIG. 3 illustrates an example of a print control screen through which file output is designated.

FIG. 4 illustrates a configuration of a touch panel.

FIG. 5 is a block diagram of a control system of the printer.

FIG. 6 is a flowchart illustrating a print/reprint process to be executed by a CPU of the printer.

FIG. 7 illustrates examples of contents displayed in a display box.

FIG. 8 illustrates an example of a job selection menu displayed in the display box.

FIG. 9 illustrates examples of contents displayed in the display box.

FIG. 10 illustrates transitions of onscreen representation for inputting a job name.

FIG. 11 illustrates transitions of onscreen representation for inputting a user name.

FIG. 12 illustrates examples of contents displayed in the display box.

FIG. 13 illustrates examples of contents displayed in the display box.

FIG. 14 illustrates transitions of onscreen representation for inputting a password.

FIG. 15 illustrates examples of contents displayed in the display box.

FIG. 16 illustrates a relationship between specifications of the printer and items of the job selection menu.

FIG. 17 illustrates an outer appearance of a multifunction device.

### DETAILED DESCRIPTION

Hereafter, an embodiment according to the invention will be described with reference to the accompanying drawings.

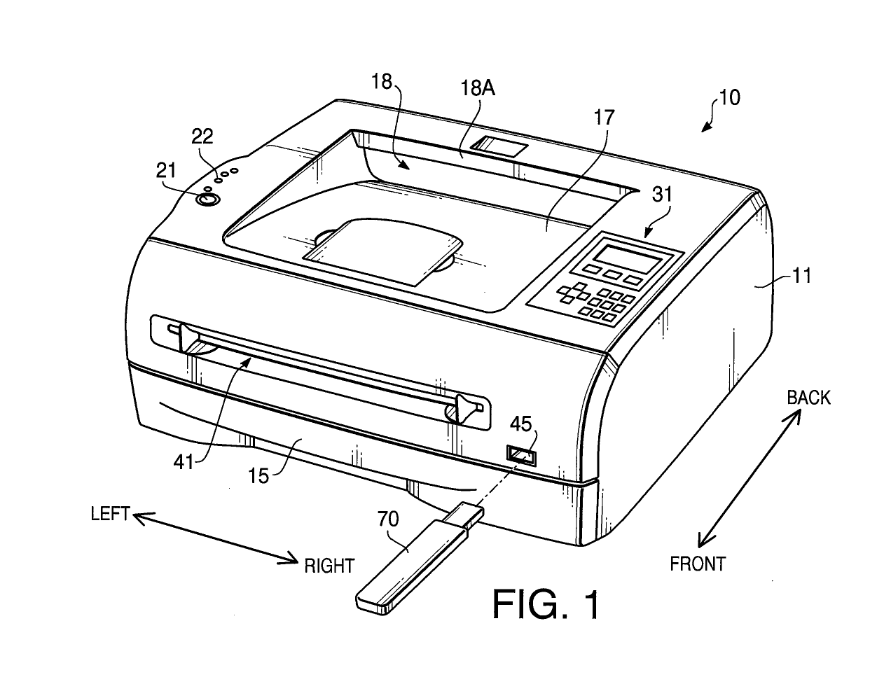

FIG. 1 is a perspective view of a printer 10 according to an embodiment. As shown in FIG. 1, the printer 10 includes a body case 11 having a box shape. On the lower side of the body case 11, a sheet supply cassette 15 is provided. The upper wall of the body case 11 has a recessed part where the upper wall gradually sinks toward the rear side to form a sheet ejection tray 17.

In the body case 11, various units such as a printing engine 61 are accommodated. In the printer 10, a sheet is supplied from the sheet supply cassette 15 to the printing engine 61 to form a desired image on the sheet. After an image is formed on the sheet, the sheet is ejected to the sheet ejection tray 17 through a sheet ejection slot 18A. On the front of the one edge part (on the front left side in FIG. 1) of the top wall of the body case 11, a power switch 21 and LEDs 22 are provided. The other edge part of the top wall is formed to have a larger width, and a touch panel 31 is formed on the other edge part.

In the front wall of the body case 11, a manual feeding slot 41 which is used to manually feed sheets is formed. On the lower right side with respect to the manual feeding slot 41, a slot 45 used to attach an external memory (e.g., a USB memory 70) is provided.

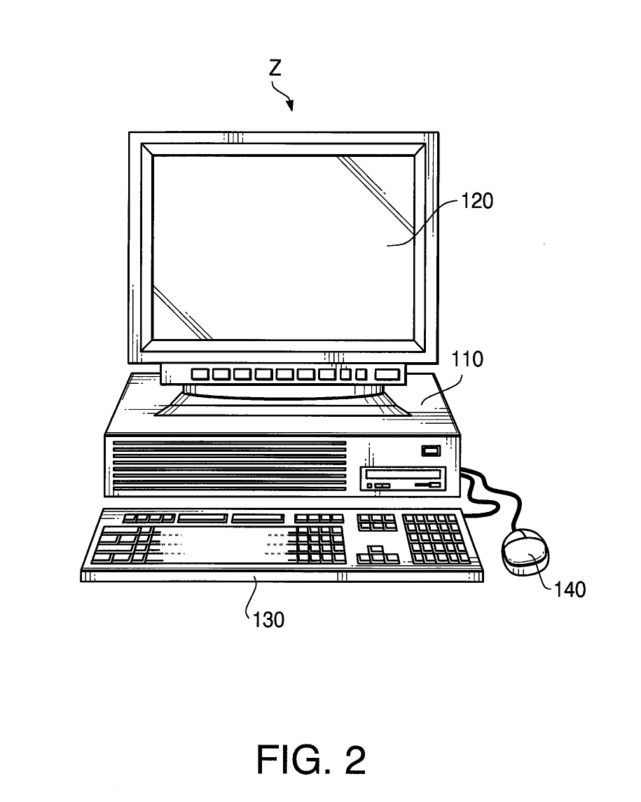

In the following, it is assumed that three files IMG-A.JPG, DOC-B.PDF and PIC-C.TIF are stored in the USB memory 70. To store the three files in the USB memory 70, a user creates each file and saves the created three files in the USB memory 70 through a computer Z (see FIG. 2). As shown in FIG. 2, the computer Z includes a display 120, a main body 110, and a user interface (e.g., a keyboard 130 and a mouse 140).

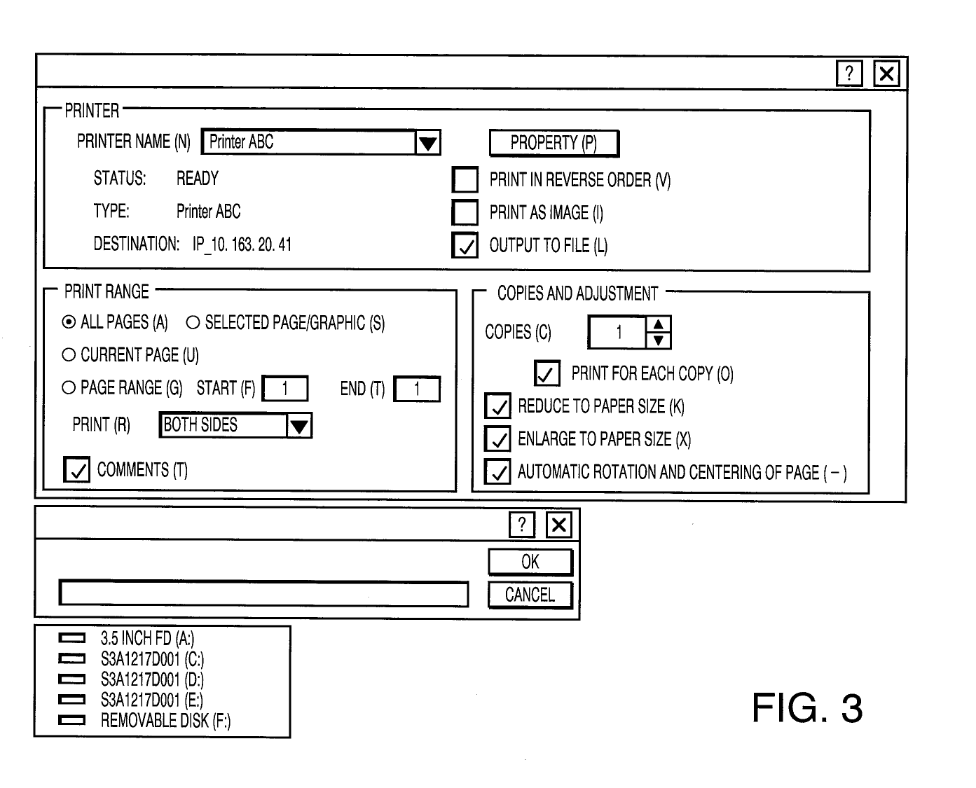

The user is able to print a file through use of the computer z. That is, the user is able to control the printer 10 through a print control screen (see FIG. 3) displayed on the display 120 of the computer z to print a file which was created on the computer z. The user is also able to directly print a file on the printer 10 without using the computer z. By attaching an external memory (e.g., the USB memory 70) to the slot 45 of the printer 10, the user is able to directly print a file stored in the external memory on the printer 10. Such a direct print operation will be described in detail later.

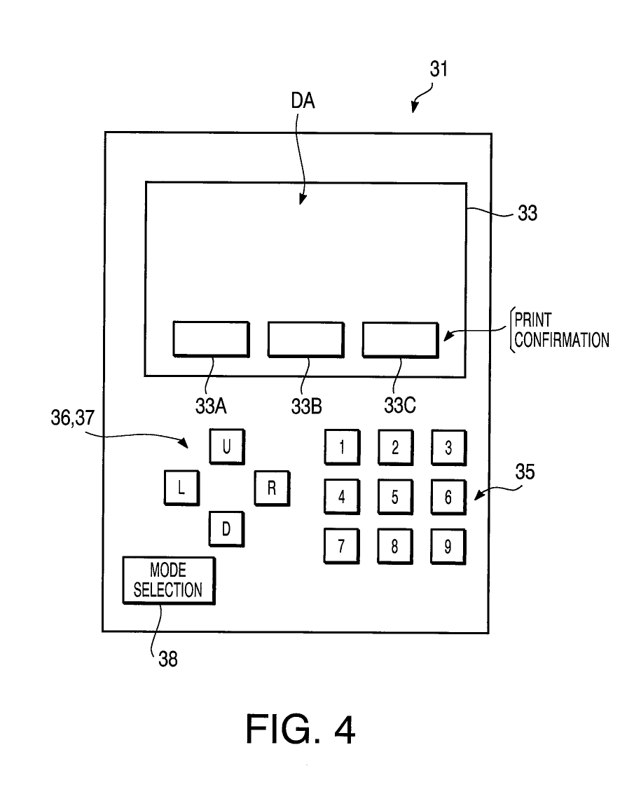

Hereafter, the touch panel 31 is explained in detail. As shown in FIG. 4, the touch panel 31 has a rectangular shape. A display box 33 is formed on the upper half part of the touch panel 31. A display area DA is located on a central part of the display box 33. On the display area DA, information is displayed in response to user operations to support input operations conduced by a user through various keys.

On the lower side with respect to the display box 33, a ten key 35, up and down keys 36, and left and right keys 37 are provided. Further, a mode selection key 38 is provided in the lower left corner. Three keys 33A, 33B and 33C are also formed in the display box 31 as displayed items. The statuses of the three keys 33A, 33B and 33C are controlled in accordance with the proceedings of the user input operation. For example, in accordance with the user operation, the three keys 33A, 33B, and 33C appear on the display box 33, the three keys are removed from the display box, or displayed contents in each of the three keys 33A, 33B, and 33C are changed. For example, a menu “Print” is displayed on the key 33C at a certain stage, while a menu “Confirmation” is displayed on the key 33C in a different stage.

As described in detail below, the user is able to input various instructions to the printer 10 while referring to contents displayed on the display area DA. The printer 10 has two modes including a print mode and a reprint mode. By operating the mode selection key 38, the user is able to select one of the two modes. The print mode is a mode where the USB memory 70 is attached to the slot 45 so that a file in the USB memory 70 is targeted for the direct print. On the other hand, the reprint mode is a mode where a printed document made by the direct print on the printer 10 is outputted again by the printer 10 (i.e., a mode where the document is reprinted).

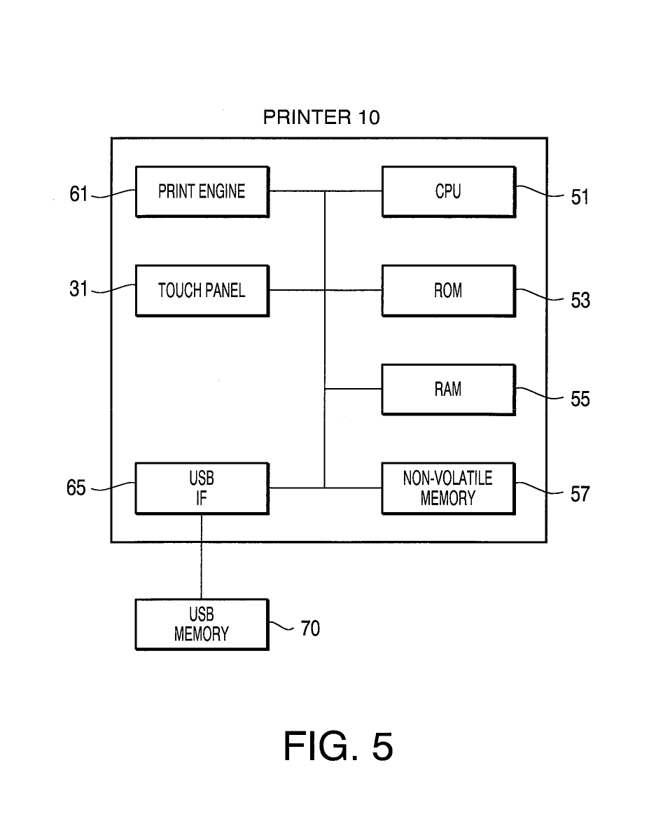

FIG. 5 is a block diagram of a control system of the printer 10. As shown in FIG. 5, the printer 10 includes a CPU 51, a ROM 53, a RAM 55, and a non-volatile memory 57. Further, the print engine 61, the touch panel 31, a USB interface 65 are connected to the CPU 51.

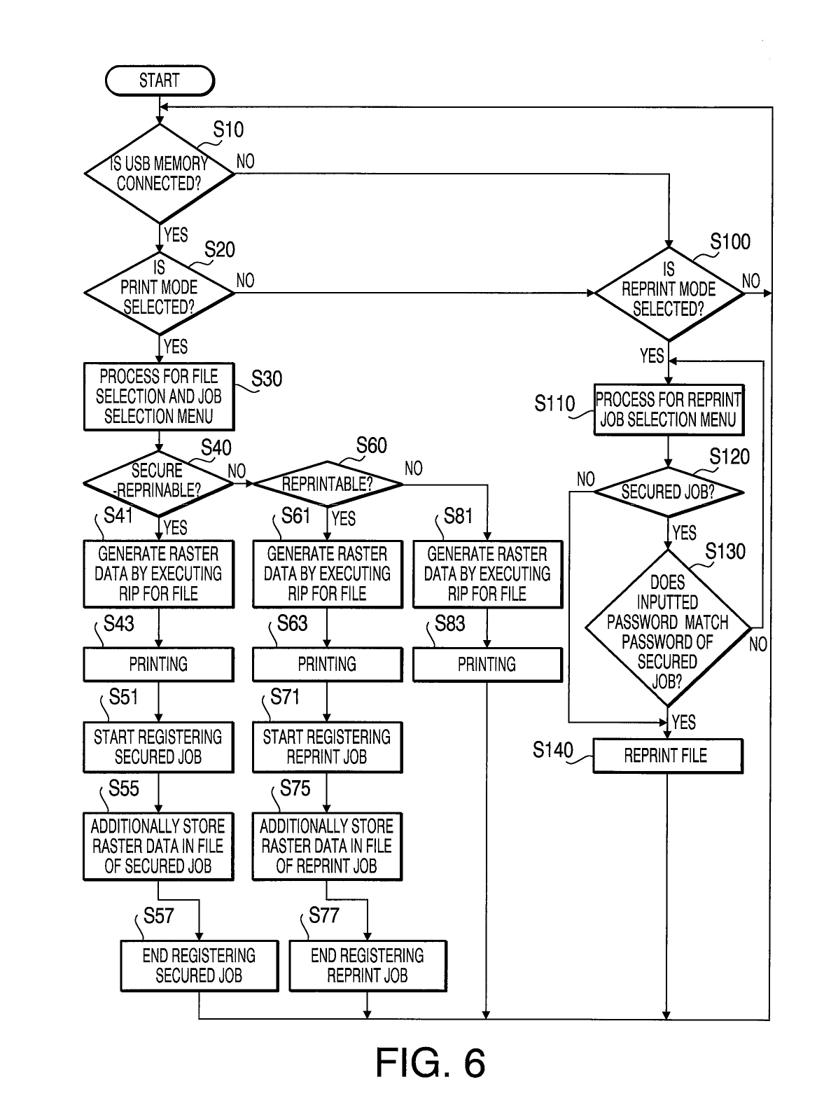

In the ROM 53, various programs, settings and initial values for controlling internal units of the printer 10 are stored. When a process is executed, a program and data are loaded on the RAM 55 from the ROM 53. By loading and executing a program, a process shown in FIG. 6 is executed by the CPU 51 so that printing operations including the above mentioned print mode and the reprint mode are executed.

The process shown in FIG. 6 starts running, for example, when the printer 10 is tuned ON. First, the CPU 51 judges whether the USB memory 70 is connected o the printer 10 (step S10). Typically, at a stage immediately following the power on of the printer 10, the USB memory 70 is not connected to the printer 10. In this case, the judgment result of step S10 is “NO”. Then, control proceeds to step S100 where the CPU 51 judges whether the reprint mode is selected. Typically, at the stage immediately following the power on of the printer 10, the CPU 51 judges that the reprint mode is not selected. Therefore, in this case, steps S10 and S100 are repeated, and the printer 10 moves to a so-called standby mode.

The standby mode is released when a user accesses the printer 10, for example, by inserting the USB memory 70 into the slot 45 or operating the mode selection key 38 to select a desired mode. When the user inserts the USB memory 70 into the slot 45 and then selects the print mode through the mode select ion key 38, the CPU 50 judges step S10 and S20 to be “YES”. Then, control proceeds to step S30.

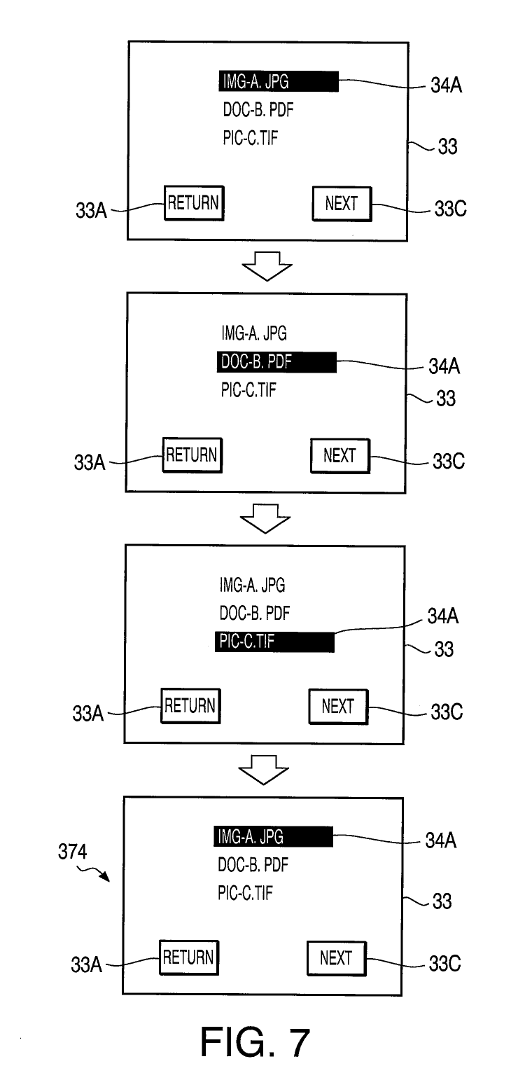

In step S30, the CPU 51 reads files from the USB memory 70. Then, file names of the files read from the USB memory 70 are displayed on the display box 33 of the touch panel 31 (see FIG. 7). In FIG. 7, “jpg”, “pdf” and “tif” represent extensions of the files.

As shown in FIG. 7, a selection bar 34A is also displayed on the display box 33 to be used as a cursor. As shown in FIG. 7, the user is able to move the selection bar 34A between positions where the file names are displayed by operating the up and down keys 36 of the touch panel 31.

When the user operates the “Next” key 33C in a state where the selection bar 34A is at the desired position, the user is able to select the file at which the selection bar 34A is situated as a print target. In the following, it is assumed that the file IMG-A.JPG is selected as a print target (see the fourth stage screen 374 in FIG. 7).

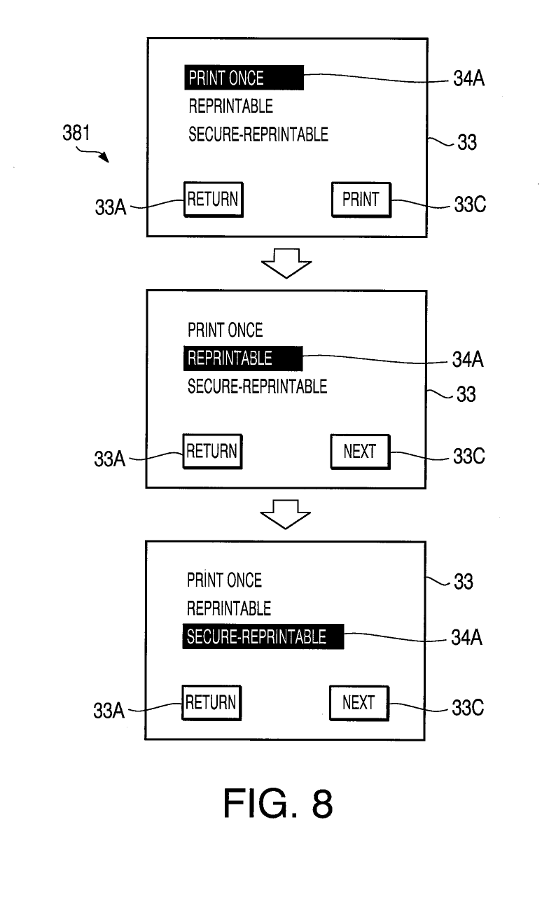

After the print target is selected as described above, onscreen representation changes to one shown in the first stage screen 381 in FIG. 8. In the first stage screen of FIG. 8, a job selection menu including “Print Once”, “Reprintable” and “Secure-Reprintable” is displayed. The user is allowed to select one of items of the job selection menu by operating the touch panel 31. More specifically, the selection bar 34A is moved between the items “Print Once”, “Reprintable” and “Secure-Reprintable” in this order by operating the up and down keys 36 of the touch panel 31 (see FIG. 8). By moving the selection bar 34A to a position of a desired item and then pressing the key 33C, the user is able to select the desired item. After the desired item is thus selected, step S30 is finished. Then, control proceeds to step S40.

As described in detail below, the process “Print Once” is defined as a process where print target data is printed once. The process “Reprintable” is defined as a process where, after print target data is printed once, a job for reprinting (including the print target data to be reprinted) is stored and no password is required in the reprinting. The process “Secure-Reprintable” is defined as a process where, after print target data is printed once, a job for reprinting (including the print target data to be reprinted) is stored and in the reprinting a password is required.

First, the case where the “Print Once” is selected is explained. In this case, the CPU 51 judges that “Secure-Reprintable” is not selected (S40: NO). Then, control proceeds to step S60 where the CPU 51 judges whether “Reprintable” is selected. Since the “Print Once” is selected, the CPU 51 judges that “Reprintable” is not selected (S60: NO). Then, control proceeds to step S81.

In step S81, the CPU 51 executes a raster image process (RIP) where the image data (i.e., the file IMG-A.JPG) selected as the print target is converted to a bitmap image to make raster data. Next, in step S83, the CPU 51 executes the print operation where the print engine 61 is driven in accordance with the raster data. Thus, an image corresponding to the file IMG-A.JPG is formed on a sheet. That is, the direct print of the file IMG-A.JPG is finished. After, the steps for the “Print Once” are finished, if the USB memory 70 is pulled out from the slot 45 of the printer 10, control enters the loop process of steps S10 and S100 again.

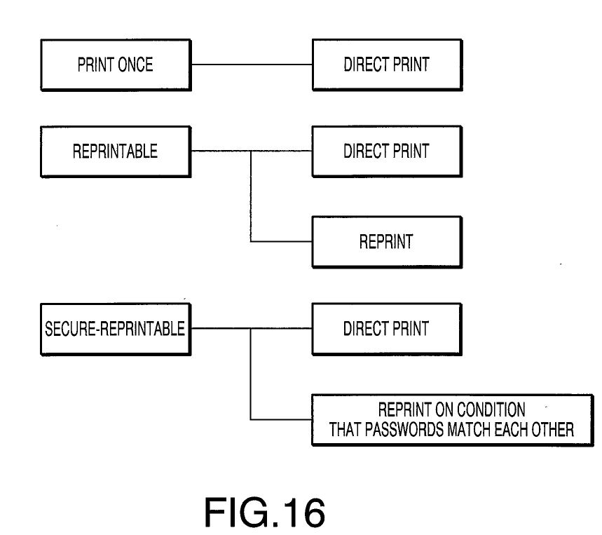

As described above, in the case where the “Print Once” is selected, the raster data of the print target (i.e., the file IMG-A.JPG) does not remain in the printer 10. Therefore, if the “Print Once” is selected, it is impossible to reprint the file IMG-A.JPG on the printer 10. To reprint the file IMG-A.JPG, the user is required to insert the USB memory 70 into the slot 45 again and then to conduct the user operation through the touch panel 31 (see FIG. 16).

It is understood that step S60 serves to selectively execute, in accordance with a user operation, a process for storing the raster data in the non-volatile memory 57 and a process for not storing the raster data in the non-volatile memory 57.

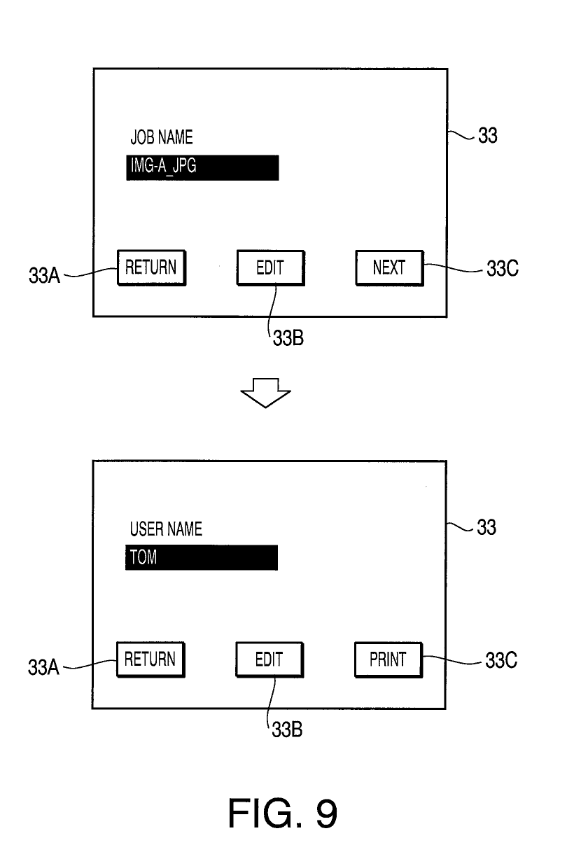

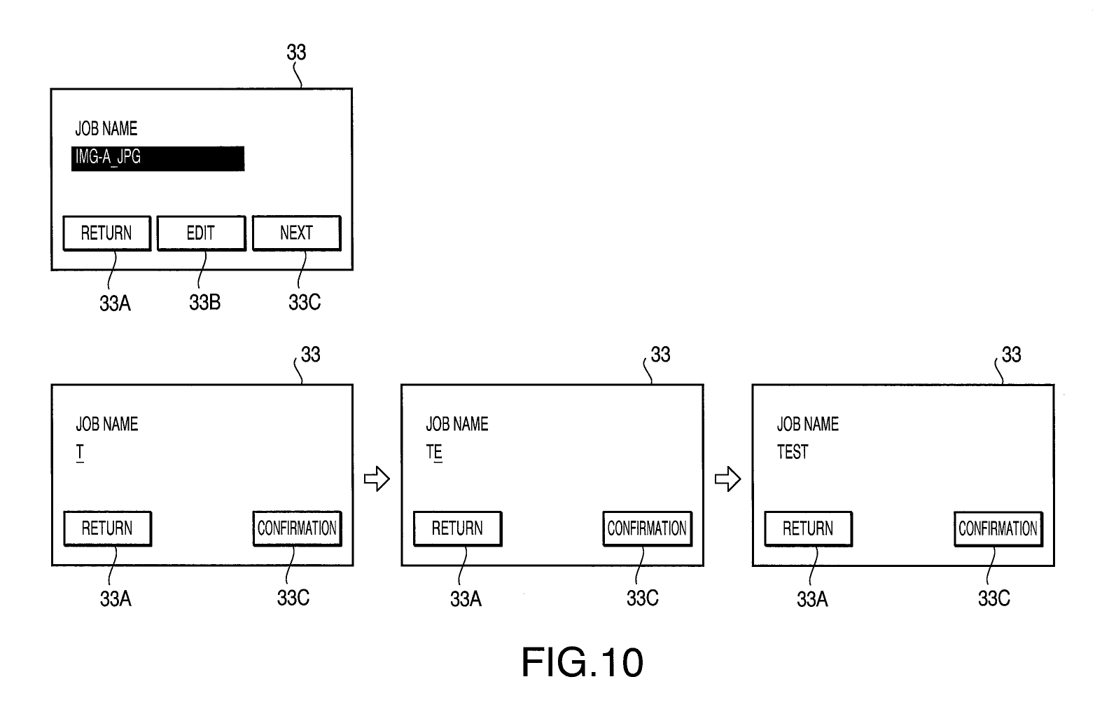

Hereafter, the case where the “Reprintable” is selected is described. When the item “Reprintable” is selected on the screen shown in FIG. 8, the onscreen representation changes to one shown in the first state screen in FIG. 9 to show a job name. Although in the example shown in FIG. 9 a filename of the file (i.e., the file IMG-A.JPG) which has been selected in step S30 is displayed as a job name, the job name can be modified by pressing the edit key 33B displayed on the lower center part of the display box 33 and then inputting a favorable job name by using various keys including the up and down keys 36 and left and right keys 37 as shown in transitions of the onscreen representation shown in FIG. 10.

By pressing the “Next” key 33C on the first stage screen of FIG. 9, selection of the job name (the job name “IMG-A_JPG” in this example) is confirmed. Then, onscreen representation changed to the second stage screen in FIG. 9.

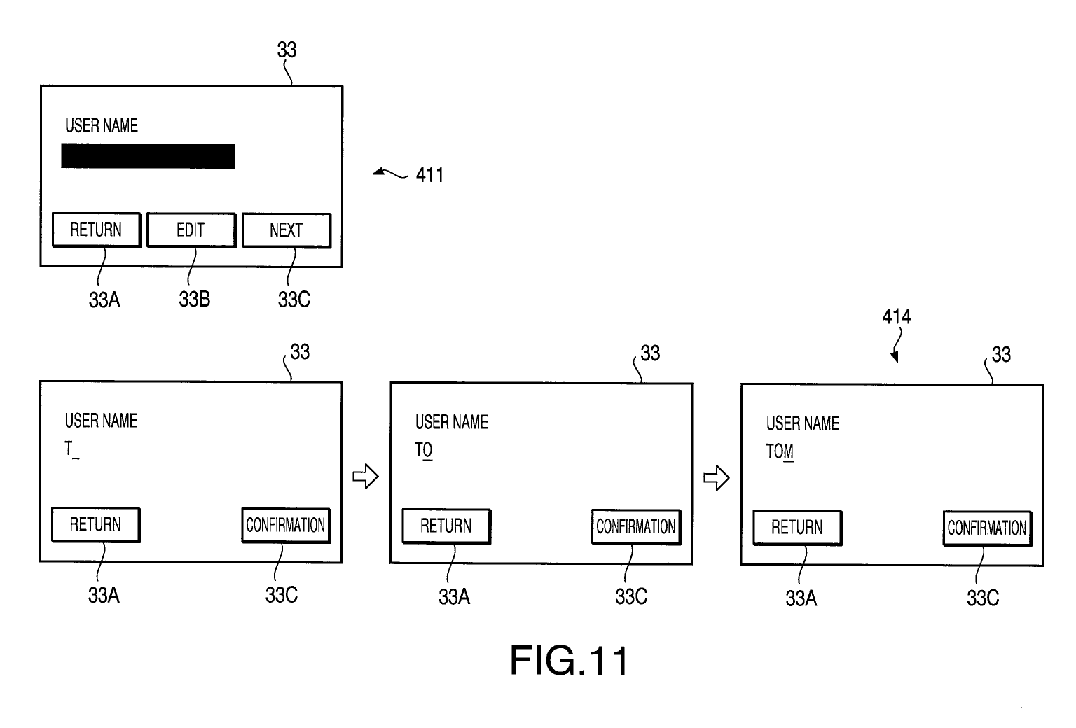

In the second stage screen of FIG. 9, “TOM” is displayed as a user name. Actually, no user name is displayed on the second stage screen of FIG. 9 immediately after the selection of the job name, as shown in the upper left screen 411 in FIG. 11. Therefore, the user enters a user name through this screen using the keys including the up and down keys 36 and the left and right keys 37.

After the user enters the user name and then presses the “Confirmation” key 33C on the rightmost screen 414 in FIG. 11, the onscreen representation moves to a state of the second stage careen of FIG. 9. In this stage, the “Print” key 33C is displayed at the lower right part of the display box 33.

By completing the above user operation, the process of step S30 is finished. Then, control proceeds to step S40. In step S40, the CPU 51 judges whether the “Secure-Reprintable” is selected. Since the currently selected item is “Reprintable”, the judgment result of S40 is NO. In step S60, the CPU 51 judges that the “Reprintable” is selected (S60: YES). Then, control proceeds to step S61.

Similarly to step S81 which is executed when the item “Print Once” is selected, the CPU 51 converts the file of the print target (i.e., the file IMG-A.JPG) to a bitmap image to create raster data. Then, control proceeds to step S63. If the “Print” key 33C of the second stage screen in FIG. 9 is selected in this stage, the CPU 51 drives the print engine 61 in accordance with the raster data to print an image corresponding to the file IMG-A.JPG on a sheet (step S63). Thus, direct print of the file IMG-A.JPG is executed.

After the file IMG-A.JPG is printed as described above, control proceeds to step S71 to register a reprint job. More specifically, the CPU 51 allocates an area exclusive to the registering in the non-volatile memory 57, and then writes the job name (i.e., “IMG-A_JPG” which has been designated by the user in step S30) and the user name (i.e., “TOM”) in the allocated area. Then, control proceeds to step S75.

In step S75, the raster data of the file (i.e., the file IMG-A.JPG) which has been targeted for the printing in step S63 is additionally stored in the area allocated at step S71. Thus, the raster data of the file of the print target, the job name inputted by the user and the user name are stored as information representing a job. The registration of a reprint job is thus finished (step S77). If the USB memory 70 is pulled out from the slot 45 afterward, control enters the loop process of steps S10 and S100 again.

As described above, if the “Reprintable” is selected from the job selection menu, the raster data of the print target (i.e., the file IMG-A.JPG) of the direct print is stored in the printer 10 as a reprint job. Therefore, if the “Reprintable” is selected, it is possible to reprint the file IMG-A.JPG through use of the printer 10 alone (see FIG. 16).

To execute the reprinting, the user is required to select the reprint mode thorough the mode selection key 38 of the touch panel 31. If the reprint mode is selected, the judgment result of step S100 is “YES”. In this case, control proceeds to step S110.

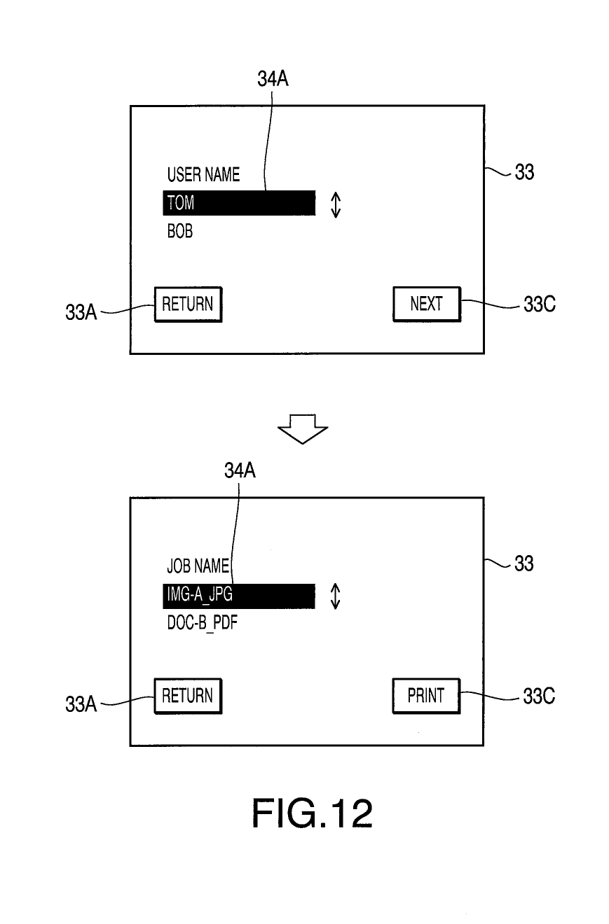

In step S110, user names currently registered are displayed in the display box 33 (see the first stage screen of FIG. 12), and the selection bar 34A is also displayed in the display box 33. By operating the up and down keys 36, the selection bar 34A moves between the displayed user names so that the user can select one of the user names. For example, by locating the selection bar 34A at a position of the user “TOM”, “TOM” is selected. Then, by pressing the “Next” key 33C at this stage, the selection of “TOM” is confirmed.

To reprint the file IMG-A.JPG which has been printed in step S63, the user selects a user name which has been inputted to the printer 10 in step S30. In this case, the user selects the user name “TOM”. After the user name is selected, onscreen representation changes to the second stage screen in FIG. 12. In this screen, a list of job names registered in association with the user name “TOM” is displayed. In the example of the onscreen representation of the second stage screen of FIG. 12, it is assumed that the job “DOC-B PDF” is also registered in association with the user name “TOM”.

After the list of the registered job names are displayed, the user is able to select one of the jobs through the touch panel 31. To reprint the file IMG-A.JPG which has been printed, the user selects the job name which has been inputted to the printer 10 in step S30. Therefore, in this case, the user selects the job “IMG-A_JPG”.

Each time selection of a job is conducted through the selection bar 34A, the CPU 51 judges whether the selected job belongs to a job of the “Secure-Reprintable” or a job of the “Reprintable” (step S120). If the selected job corresponds to a job of “Secure-Reprintable” (S120: YES), control proceeds to step S130. If the selected job corresponds to a job of “Reprintable” (S120: NO), control proceeds to step S140.

In the example of FIG. 12, the job “IMG-A_JPG” has been registered as a job of “Reprintable” in step S75. Therefore, the judgment result of step S120 is “NO”, and control proceeds to step S140. In step S140, printing of the print target is permitted. Thus, “Print” is displayed on the key 33C located under right part of the display box 33 as shown in the second stage screen in FIG. 12. After the “Print” key 33C is displayed, the user is able to instruct the printer 10 to print the print target by operating the “Print” key 33C.

If the selected job “IMG-A_JPG” belongs to “Secure-Reprintable”, “Next” is displayed on the key 33C in place of displaying “Print” on the key 33C. If the instruction to print the print target is inputted to the printer 10 through the “Print” key 33 C, the reprint job registered under the job name “IMG-A_JPG” is read by the CPU 51 from the non-volatile memory 57. That is, the raster data stored in association with the job name “IMG-A_JPG” is read, and the internal units such as the printer engine 61 is controlled in accordance with the read raster data.

Thus, the file IMG-A.JPG is printed in step S140. After step S140 is finished, control returns to step S10. In this case, control enters the loop process (i.e., the standby state) of steps S10 and S100 to wait for user's access.

It is understood that step S40 serves to selectively execute, in accordance with a user operation, a process where consistency between passwords is required as an execution condition and a process where consistency between passwords is not required.

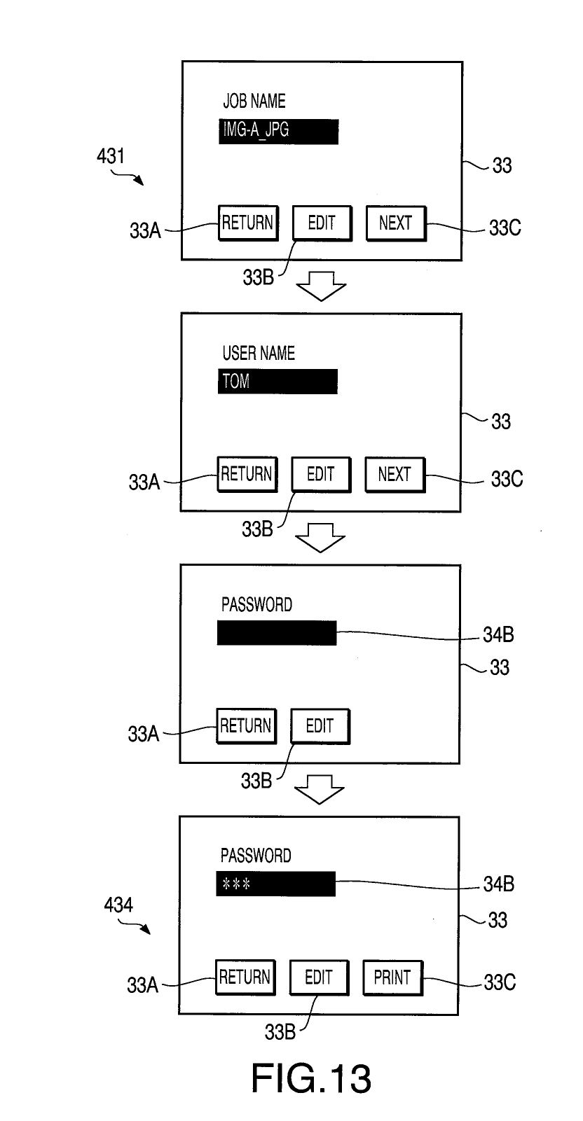

Hereafter, the case where the “Secure-Reprintable” is selected on the screen shown in FIG. 8 is described. Similarly to the case where the “Reprintable” is selected, onscreen representation as shown in FIG. 13 is made on the display box 33 when the “Secure-Reprintable” is selected. In this case, the user inputs a job name and a user name through the touch panel 31.

More specifically, when the user selects the item “Secure-Reprintable” on the first stage screen of FIG. 8, onscreen representation changes to the first stage screen 431 of FIG. 13. Since the job name is displayed on the screen, the user selects a job which will be stored as a secured job in a later stage by pressing the “Next” key 33C. After the “Next” key 33C is pressed as described above, the onscreen representation changes to the second stage screen in FIG. 13. In this second stage screen, the user is able to input a user name. By pressing the “Next” key 33C after the user name is inputted, designation of the user name is confirmed. It is understood that the aforementioned steps are substantially equal to those in the case where the “Reprintable” is selected (see FIG. 9).

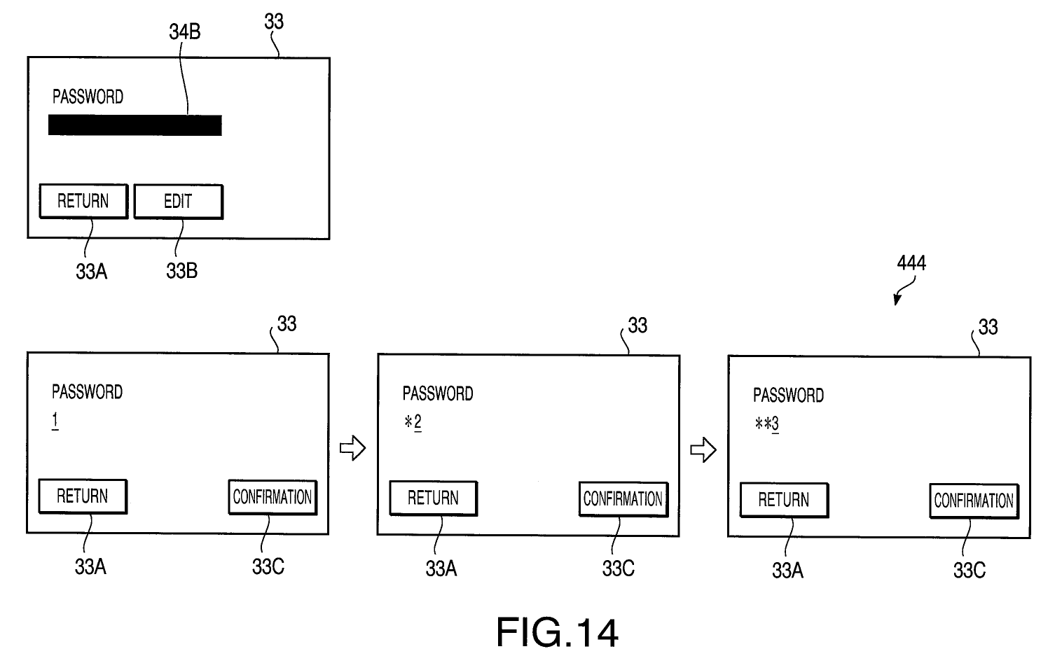

After the designation of the user name is confirmed through the “Next” key 33C, onscreen representation changes from the second stage screen to the third stage screen in FIG. 13. In the third stage screen in FIG. 13, a password input field 34B is displayed on the lower side with respect to words “PASSWORD”. In this stage, the user is able to input a password through the ten key 35 on the touch panel 31. FIG. 14 shows an example of onscreen representation during the input operation of the password. After the user inputs a password, the user is able to confirm the designation of the password by pressing the “Confirmation” key 33C located on the lower right part of the last stage screen 444 of FIG. 14.

After the designation of the password is confirmed as described above, onscreen representation changes to the fourth stage screen 434 shown in FIG. 14. At this stage, the “Print” key 33C is displayed in the lower right part of the display box 33. As described above, if the “Secure-Reprintable” is selected, the “Print” key 33C is displayed on the display box 33C only when the input of the job name, the use name and the password is completed. By operating the “Print” key 33C, the user is able to instruct the printer 10 to execute the printing operation. By completing the above mentioned user operation, the process of step S30 is finished.

After the user operation is thus conducted by the user, such user operations are detected by detection means (not shown) in the printer 10 and detected signals are transmitted to the CPU 51. Thus, the process of the flowchart shown in FIG. 6 is executed by the CPU 51 while processing various judgment steps according to the user operations. After step S30 is processed, control proceeds to step S40 where the CPU 51 judges whether “Secure-Reprintable” is selected. In this case, the judgment result of step S40 is “YES”. Then, control proceeds to step S41.

Similarly to the case where the “Print Once” or “Reprintable” is selected, the CPU 51 converts the file (i.e., the file IMG-A.JPG) selected as the print target in step S30 to a bitmap to form raster data (step S41). Then, the CPU 51 drives the print engine 61 in accordance with the raster data to print an image corresponding to the file IMG-A.JPG on a sheet (step S43). That is, the direct printing is conducted.

After the file IMG-A.JPG is thus printed, control proceeds to step S51 to start a process for registering a secured job. More specifically, the CPU 51 allocates an area exclusive to the registering in the non-volatile memory 57, and then writes the job name (i.e., “IMG-A_JPG” which has been inputted by the user in step S30) and the user name (i.e., “TOM”) in the allocated area. Further, in this case, the CPU 51 writes the password in the allocated area (step S51). Then, control proceeds to step S55.

In step S55, the raster data of the file (i.e., the file IMG-A.JPG) which has been targeted for the printing in step S43 is additionally stored in the area allocated at step S51. Thus, the raster data of the file of the print target, the job name inputted by the user, the user name and the password are stored as information representing a secured job. If the USB memory 70 is pulled out from the slot 45 afterward, control enters the loop process of steps S10 and S100 again.

As described above, if the “Secure-Reprintable” is selected from the job selection menu, the raster data of the print target (i.e., the file IMG-A.JPG) of the direct print is stored in the printer 10 as a secured job. Therefore, if the “Secure-Reprintable” is selected, it is possible to reprint the file IMG-A.JPG through use of the printer 10 alone (see FIG. 16).

To execute the reprinting, the user is required to select the reprint mode thorough the mode selection key 38 of the touch panel 31. If the reprint mode is selected, the judgment result of step S100 is “YES”. In this case, control proceeds to step S110.

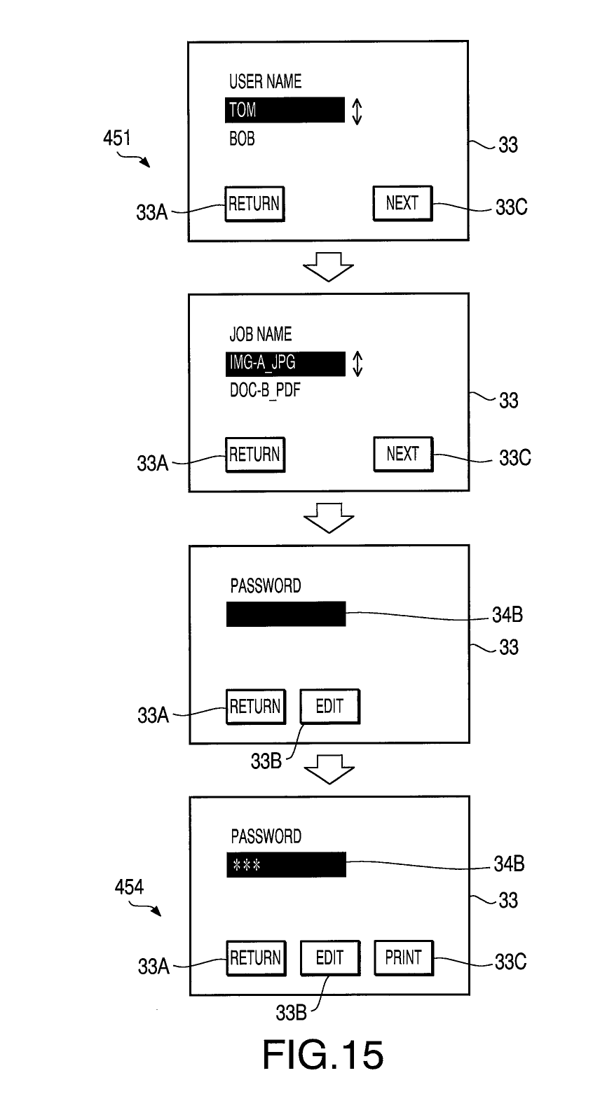

In step S10, user names currently registered are displayed in the display box 33 (see the first stage screen 451 of FIG. 15), and the selection bar 34A is also displayed in the display box 33. By operating the up and down keys 36, the selection bar 34A moves between the displayed user names so that the user can select one of the user names. After the selection is finished, the selection can be confirmed by pressing the “Next” key 33C.

To reprint the file IMG-A.JPG which has been printed in step S43, the user selects a use's user name which has been inputted to the printer 10 in step S30. In this case, the user selects the user name “TOM”. After the user name is selected, onscreen representation changes to the second stage screen in FIG. 15. In this screen, a list of job names registered in association with the user name “TOM” is displayed.

After the list of the registered job names are displayed, the user is able to select one of the jobs through the touch panel 31. To reprint the file IMG-A.JPG which has been printed, the user selects the job name which has been inputted to the printer 10 in step S30. Therefore, in this case, the user selects the job “IMG-A_JPG”. The job “IMG-A_JPG” belongs to the item “Secure-Reprintable” registered as a secured job in step S51. If a job corresponding to a secured job is selected, onscreen representation changes from the second stage screen to the third stage screen in FIG. 15.

In the third stage screen, an input field 34B is displayed under the words “PASSWORD”. The user is allowed to enter a password to the input field 34B by operating the ten key 35 of the touch panel 31. When the user inputs a password, the onscreen representation is switched to ones shown in FIG. 14. As described above, FIG. 14 shows transitions of the onscreen representation during the input operation of the password. By operating the “Confirmation” key 33C located the lower right portion in the display box 33 on the last stage screen 444 of FIG. 14, the inputted password is confirmed.

Concurrently with the input operation of the password, the CPU 51 executes step S120. In step S120, the CPU 51 makes a judgment about an attribute of the job selected by the user. Since the job “IMG-A_JPG” for which an attribute is checked is a job registered as a secured job in step S51, the judgment result of step S120 becomes “YES”. Then, control proceeds to step S130.

In step S130, the CPU 51 accesses a memory area in which the secured job is registered, and the password of the secured job “IMG-A_JPG” is read from the memory area. Then, the CPU 51 judges whether the password read from the memory area and the password designated in step S110 match each other. If these passwords match each other, the onscreen representation changes from the state shown in FIG. 14 to a state shown in the forth stage screen 454 in FIG. 15. In this case, the “Print” key 33C is displayed in a lower right portion of the display box 33 (S130: YES).

After the “Print” key 33C is thus displayed, the user is able to input a print instruction to the printer 10 to execute the print operation by pressing the “Print” key 33C. After the print instruction is inputted to the printer 10, the raster data of the secured job registered under the name “IMG-A_JPG” is read from the non-volatile memory 57, and the internal units such as the print engine 61 are driven by the CPU 51 in accordance with the raster data. The file IMG-A.JPG is thus reprinted (step S140).

If the two passwords do not match each other, the judgment result of step S130 becomes “NO”, and control returns to step S110. In this case, the user conducts the menu process (i.e., input of a job name, a user name and a password) again. The CPU 51 judges that the two passwords do not match each other, for example, if the user inputs an incorrect password by mistake. However, in this case, the user is able to re-input a correct password since control returns to step S110 when such inconsistency between the two passwords is detected in step S130. By re-inputting a correct password, the use r is able to reprint the file IMG-A.JPG.

If the CPU 51 judges that the two passwords do not match each other a plurality of times (e.g., three times), an error process (e.g., a process for informing the user of defective conditions) is executed by the CPU 5 1. In this case, it is impossible to reprint the file IMG-A.JPG registered as the secured job.

Hereafter, advantages of the embodiment are described. As described above, by keeping, in the printer 10, the image (i.e., the raster data) which has been read from the USB memory 70 and has been subjected to the direct printing, the same image can be reprinted using the saved raster data through use of the printer 10 alone. In particular, by keeping the raster data which a resultant of the RIP process, it is possible to reduce time required to complete the reprinting from an instruction of reprint.

There is a possibility that if raster data is stored in a printer, another user prints the raster data remaining in the printer. In this regard, the printer 10 according to the embodiment is configured to require consistency of passwords. Therefore, according to the embodiment, it is possible to prevent the data remaining in the printer 10 from being printed freely by another user. That is, security of image data can be achieved.

On the other hand, if consistency of passwords is required, a password input operation becomes a necessary operation. Such a password input operation is troublesome for the user. Further, there is a case where the user thinks that image data to be printed (i.e., to be saved) does not need security. For this reason, in this embodiment, two process items of “Secure-Reprintable” and “Reprintable” are provided.

If the “Reprintable” is selected, the printer 1 0 does not require consistency of passwords. In this case, the user is not required to input a password. Therefore, the user is allowed to select “Reprintable” for a print target for which security is not needed. Such a configuration makes it possible to print or reprint a print target without conducting troublesome operations.

In addition, according to the embodiment, the user is allowed to select the process item “Print Once”. By selecting the “Print Once”, the user is able to prevent raster data (e.g., data having a high level of confidentiality) from remaining in the printer 10 although in this case the user is not able to execute the reprinting for the print target of the process item of “Print Once”.

Since consistency between the two passwords (first authentication information and second authentication information) is required to execute the reprinting, it is possible to limit users capable of executing the reprinting to a first person who has inputted the first authentication information or a second person who is provided the first authentication information from the first person.

Although the present invention has been described in considerable detail with reference to certain preferred embodiments thereof, other embodiments are possible.

In the above mentioned embodiment, the printer 10 employs a USB memory as an external storage device. However, it should be noted that the USB memory is one example of an external storage device. Various types of portable storage devices (i.e., removable media) can be employed as an external storage device.

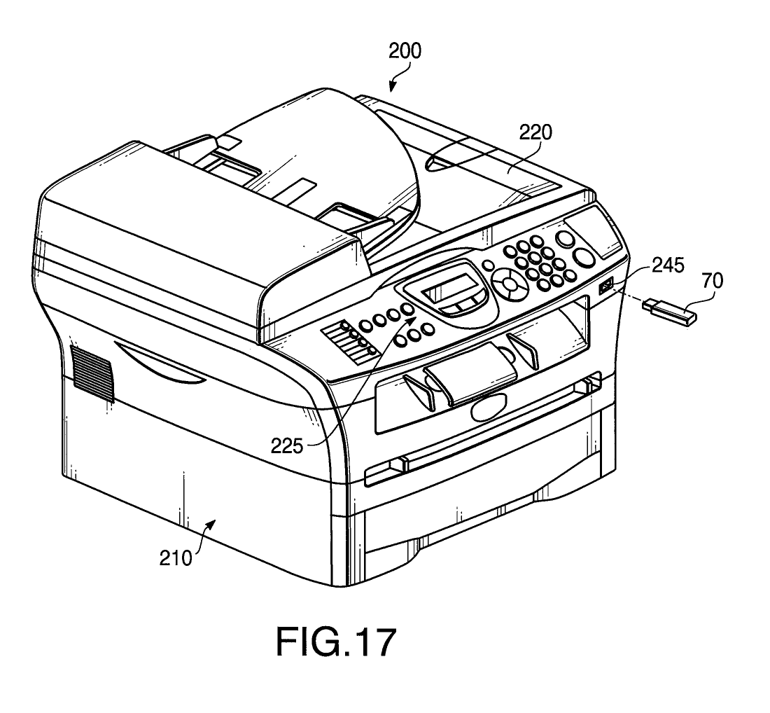

In the above mentioned embodiment, a printer having only a printing function is used as an image forming device to which the embodiment is applied. However, the embodiment can also be applied to various types of image forming devices such as a multifunction device 200 (a device having a multiple functions of a facsimile function, a scanner function and a printing function) shown in FIG. 17. The multifunction device 200 is configured such that a portable storage device (removable media) such as a USB memory can be attached thereto. As shown in FIG. 17, the multifunction device 200 includes a main body 210 and an image reading unit 220. On the front top of the main body 210, an operation unit 225 is provided. Further, in the front side of the main body 210, a slot 245 is formed so that the USB memory 70 can be connected to an internal control unit of the multifunction device 200 via the slot 245. By operating the operation unit 225, the user is able to display the job selection menu (including “Print Once”, “Reprintable” and “Secure-Reprintable”) and to select a desired job item.

In the above mentioned embodiment, the raster data is stored in the non-volatile memory 57. However, a memory to which the raster data is stored is not limited to the non-volatile memory 57. For example, the raster data may be stored in an internal storage device such as the RAM 55.

What is claimed is:

1. An image forming device, comprising:
a print unit;
a connection unit to which an external device is detachably attachable;
a print control unit configured to control the print unit in accordance with print target data read from the external device attached to the connection unit to form an image corresponding to the print target data on a recording medium;
a storage unit used to store the print target data which has been printed via the print unit;
an authentication information input unit configured to accept input of authentication information; and
a judgment unit configured to judge whether to permit execution of reprinting of the print target data stored in the storage unit in accordance with the authentication information.

2. The image forming device according to claim 1, further comprising a data conversion unit configured to convert the print target data read from the external device attached to the connection unit into raster data,
wherein:
the print control unit controls the print unit in accordance with the raster data to form the image corresponding to the print target data on a recording medium; and
the storage unit stores the raster data as the print target data.

3. The image forming device according to claim 2, wherein:
first authentication information is inputted through the authentication information input unit in a stage of storing the raster data of the print target data in the storage unit;
second authentication information is inputted through the authentication information input unit in a stage of executing the reprinting of the print target data; and
wherein the judgment unit permits the reprinting of the print data in response to a fact that the first authentication information and the second authentication information match each other.

4. The image forming device according to claim 3, further comprising a first operation control unit configured to selectively execute an operation where the raster data is stored in the storage device and an operation where the raster data is prevented from being stored in the storage unit.

5. The image forming device according to claim 3, further comprising a second operation control unit configured to selectively execute an operation where consistency between the first authentication information and the second authentication information is required as an execution condition for the reprinting and a process where consistency between the first authentication information and the second authentication information is not required as an execution condition for the reprinting.

6. An image forming device, comprising:
a print unit;
a connection unit to which an external device is detachably attachable;
a storage unit used to store print target data which has been printed via the print unit; and
a print control unit configured to store, at a stage where the print target data read from the external device attached to the connection unit is stored in the storage unit, authentication information used to judge whether to permit reprinting of the print target data in the storage unit.

7. The image forming device according to claim 6, wherein the print control unit stores the print target data and the authentication information in the storage unit at a stage where the print target data is subjected to a printing operation executed through the printing unit.

8. The image forming device according to claim 6, further comprising a judgment unit configured to judge whether to permit the reprinting of the print target data based on the authentication information stored in the storage unit together with the print target data.

9. A method of controlling reprinting executed on an image forming device, comprising the steps of:
controlling a print unit in accordance with print target data read from an external device attached to the image forming device to form an image corresponding to the print target data on a recording medium;
storing the print target data which has been printed via the print unit in a storage unit;
accepting input of authentication information; and
judging whether to permit execution of reprinting of the print target data stored in the storage unit in accordance with the authentication information.

10. The method according to claim 9, further comprising the step of converting the print target data read from the external device attached to the connection unit into raster data, wherein:
in the controlling step the print unit is controlled in accordance with the raster data to form the image corresponding to the print target data on a recording medium; and
in the storing step the raster data is stored in the storage unit as the print target data.

11. The method according to claim 10, wherein:
the accepting step comprises:
accepting first authentication information in a stage of storing the raster data of the print target data in the storage unit; and
accepting second authentication information in a stage of executing the reprinting of the print target data,
wherein in the judging step the reprinting of the print data is permitted in response to a fact that the first authentication information and the second authentication information match each other.

12. The method according to claim 11, further comprising the step of selectively executing an operation where the raster data is stored in the storage device and an operation where the raster data is prevented from being stored in the storage unit.

13. The method according to claim 11, further comprising the step of selectively executing an operation where consistency between the first authentication information and the second authentication information is required as an execution condition for the reprinting and a process where consistency between the first authentication information and the second authentication information is not required as an execution condition for the reprinting.
